(19) United States
(12) Patent Application Publication
(10) Pub. No.: US 2017/0367358 A1
(43) Pub. Date: Dec. 28, 2017

(54) SOLID STATE, FRESH JOGURT CHEESE WITH LIVE AND ACTIVE CULTURES AND CHOCOLATE COVERED YOGURT DESSERT MADE OF IT, AND PROCESS FOR THEIR PREPARATION

(71) Applicant: Attila Rakosi, Budapest (HU)

(72) Inventor: Attila Rakosi, Budapest (HU)

(21) Appl. No.: 15/543,796

(22) PCT Filed: Jan. 13, 2016
(86) PCT No.: PCT/HU2016/000004

§ 371 Date: Jul. 14, 2017

(30) Foreign Application Priority Data
Jan. 15, 2015 (HU) P1500011

(51) Int. Cl. A23C 9/123; A23C 19/032; A23C 9/13

(52) U.S. Cl. CPC A23C 9/123; A23C 9/1307; A23C 19/0323

(57) ABSTRACT

Yogurt dessert piece products are of firm consistency, made on the base of fresh yogurt cheese, coated with chocolate or cocoa-flavored icing, with live bacterial flora, of rectangular design, the main component of which is fresh yogurt cheese with live bacterial flora, of firm consistency, obtained from milk or milk recombined from milk powder with water to a thicker consistency than milk, or milk concentrated by ultra-filtering or milk concentrated with milk powder; its curdling by a yogurt culture, occasionally its supplementary acidic treatment; the cutting of the curd, its solidification by heating, and the separation of the separated whey, and method for producing them.

### CROSS-REFERENCE TO RELATED APPLICATIONS

This application is the §371 National Stage of International Application Serial No. PCT/HU2016/000004, filed on Jan. 13, 2016, which claims the benefit of Hungarian Patent Application Serial No. P1500011, filed on Jan. 15, 2015, the contents of which applications are herein incorporated by reference in their entirety.

### FIELD OF THE INVENTION

The present invention relates to fresh yogurt cheese and related products and processes.

### BACKGROUND OF THE INVENTION

Russia and several East European countries produce as acidic (sour) milk product of solid consistency by inoculating milk with a mesophilic lactic acid bacteria culture, and fresh cheese for food (quark) occasionally by supplementary curdling with rennet, and chocolate- or cocoa-paste-coated quark desserts comprising that in the amount of min. 50% (w/v). However, fresh cheese (quark) produced by this method and the quark desserts made on its base have not spread beyond the above-mentioned geographical area.

It is assumed that the more extensive global spread of quark and quark desserts is hindered by several factors:
Quark is not known where it is not a traditional product and, therefore, people are reluctant to try quark and the products, thus quark desserts, made of it.
Many among those who know quark and the products made of it assign low prestige value to them and consequently abstain from consuming them.
For a part of people, the taste of quark and quark desserts is not harmonious enough, not sufficiently rich in aroma due to the use of curdling by a mesophilic lactic acid bacteria culture.

Yogurts and yogurt desserts are very common and popular globally due to their advantageous nutritional and organoleptic properties. Under yogurts and yogurt desserts coagulated sour milk products are those made of milk and milk products (milk, skimmed milk, concentrated milk, concentrated skimmed milk, cream, cream and their mixtures), produced by lactic curdling mainly under the effect of thermophilic micro-organisms originating from Streptococcus thermophilus and Lactobacillus delbrueckii bulgaricus cultures. The name “yoghurt” can be used rightfully if an adequate number of n of living entities of these two bacterial strains are present in the product.

The traditional, commonly known and most widespread method of yoghurt production: inoculating pasteurized and homogenised cow milk set at the desired fat content by a yogurt lactic acid bacteria culture, curdling it at a temperature of around 42° C. that is ideal for bacterial fermentation until the desired acidity preferably of a pH value of 4.2 to 4.8, is attained. The plain yogurt curd prepared this way is cooled to a temperature of preferably 20° C. and poured into cups or used as raw material of various flavoured yogurt desserts.

During the production of traditional yogurt desserts, various additional substances are added to the yogurt curd: at the start of the procedure, e.g. sugar or cream is added to the raw material milk and at the end of the procedure, e.g. fruit jelly or fruit pieces are mixed into the yogurt curd, it is poured into cups, closed, and stored refrigerated, or protein stabiliser additives are added to extend shelf-life, then it is pasteurized, poured into cups hot, closed and cooled down.

According to the patent specification No. E 002 213 of Compagnie Gervais Danone, Paris, e.g. sugar or sweeteners, flavours, fruit, wheat or some nutrients, e.g. vitamin, mineral and fibrous substances, may be added to the finished yogurt. In addition, various dairy raw materials, e.g. powder milk, skimmed powder milk, lactone serum, milk proteins, edible casein may also be added. The main characteristic of the solution laid down in the patent specification in question is that the yogurt is of “bimodal structure”, it contains flat globules connected to the protein-fat substance network and free fat globules (the diameters of these fat globules are divided between two main values, this is why it has a “bimodal structure”), and it contains also homogenized cream of 7-14% (w/v) of the product.

Manufacturing the flavoured yogurt dessert being the subject of the Hungarian patent No. 19750 Á is characterised by milk being concentrated by mixing hydrocolloids into it, it is homogenized, pasteurized, cooled to a temperature of 35° C., cultured in the known way, fermented to a pH value of 4-4.5 in 12-16 hours, another amount of hydrocolloid is added to the yogurt curd, it is subjected to post-heat-treatment and poured into cups in a semi-aseptic way and cooled.

It is a common feature of industrially globally produced traditional yogurt products that their consistency is either free-flowing—these are the yogurt drinks—, or pulpy-flowing or spoonable, or creamy and, accordingly, they are packaged for the market in bottles in the case of yogurt drinks and in cups or boxes in that of other yogurt products, as they are not solid and shape-sustaining.

In recent years, the so-called greek style yogurts or “strained yogurts” having a higher dry matter content and therefore higher nutritional and enjoyment value than the traditional ones have enjoyed great popularity. As opposed to the maximum dry matter content of traditional yogurts of 10% (w/v), they have a dry matter content of around 20% (w/v). The known, most general method of producing greek style yogurt is to remove a part of the whey/water content by mechanical/ultra-filtering from the traditional yogurt. For example the document Food Processing Principles and Applications, 18. Dairy—Fermented Products, Second Edition, WILEY Blackwell, pages 411-422 (2014) refers to preparation of greek style yogurts of high dry matter content (20-25%). According to the process this dry matter content is reached by centrifuging twice. These high solids products are used as milk protein concentrates.

The “Labneh” type thick yogurts are widespread in the countries of the Middle East, which are made with dry matter-content, on an average 22-27 percentage by weight (w/v). These are soft, non-shape-sustaining products of spreadable consistency, usually marketed in plastic boxes. Such as e.g. the “Labneh” product of the Canadian Phoenicia Group company that contains 27% (w/v) dry matter, marketed in plastic jar.

Greek style yogurts are soft, hence are not convenient for production of shape-sustaining dessert corpuses. As raw material they are utilizable for yogurt dessert production according to invention.

Food composition according to invention PCT/FR 9500206 (C. G. DANONE) contains pastry or chocolate coating and filling. The yogurt content of filling is 20-25% (w/v). High water content (88-90%) of used natural yogurt sets a problem at composition. Hence to ensure required water activity value (a_{w}) to retain living bacterial flora they are obliged to stabilize the lots of water with 15-35% (w/v) of fat.

This low viscosity filling cannot form a shape-sustaining solid dessert corpus itself. This filling can form a solid corpus jointly with the pastry ingredient of composition as it is apparent from the document. Composition according to the document is not included in yogurt desserts, as application of the natural yogurt ingredient in the composition did not enable achievement of the required 70% (w/v) milk-based simple product ratio.

Yogurt bar product of company Ferrero Rocher consists of two sponge flans and the filling between them. Filling contains 29.5% (w/v) yogurt, not condensed to solid consistency.

However condensed yogurt is heat treated, therefore it is not a living flora ingredient. Solidity of bar is ensured by the two sponge slices bracketing the filling, identical to former example.

Invention P0600733 (C. G. DANONE) refers to preparation and chocolate coating of a milk-based high water content corpus. Invention claims refer to methods for reduction of corpus water content. The document does not mention yogurt ingredient or existence of living bacterial flora inside the corpus.

Invention P0600314 (FRIESLAND HUNGARIA) refers to yogurt based fresh cheese dessert product. According to the document yogurt and fresh cheese are prepared and mixed with sugar and other ingredients. The mass is heat treated at 68-76° C., then packed. The product is not a solid consistency piece good. It does not contain living bacterial flora and chocolate coating.

Invention P0400763A (C. G. DANONE) describes a fresh cheese cream product and a milk dessert prepared based on it, as well as the method for producing them. By acidic curdling with mesophilic bacteria fresh cheese is made of milk. According to procedure curdling happens at 22-36° C. until reaching 4-5 Ph value, curd is cut into 2-10 cm cubes and heated to 65-75° C., and at this temperature it is pressed until reaching dry matter content of 35-50% (w/v), intensively mixed in a cutter of strong cutting effect, and is meanwhile cooled by inert gas of −40- -160° C., then butter is mixed therein. This way buttery fresh cheese cream is produced, containing 1-5% gas in its volume. Milk dessert reaches completion by mixing gas containing buttery fresh cheese cream with other additives, forming/extruding of mixture at 10-14-19-23-28-31° C., cutting, then coating with covering mass. The document contains description of the strong cutting effect cutter equipment applied for production of fresh cheese cream.

Fresh cheese cream and dessert according to the document does not contain yogurt bacterial flora. According to the document these are not chilled products, but confectionery goods to be consumed immediately, duly neither they are wrapped.

The procedure according to the document is complicated, contains several technological deficiencies, of which only a part can be amended by extra devices, operations:
curd is heated to 65-75° C. and pressed. However at this temperature lactoproteins are partially denaturated and hard dehydrated cores originate inside, which worsen the quality of product and reduce its enjoyment value. Enjoyment value is partly improved by application of a strong cutting effect cutter equipment, which shreds the cores, but at the same time destroys the protein reticulation ensuring solidity of fresh cheese and does not amend occurred protein denaturation,
strong cutting effect cutter equipment consumes much electric energy during operation, this amount of energy raises the temperature of fresh cheese cream. Cream is cooled by an expensive and high energy consuming method, liquid nitrogen,
by the fault of procedure fresh cheese cream does not possess protein reticulation ensuring solidity, hence they are obeyed to reach solidity through raising dry matter content of fresh cheese component to the value of 35-50% (w/v). This reduces the amount of end product produced of milk.

The procedure according to the document does not include chocolate coating of dessert corpuses.

A procedure is applied to precipitate milk curdling at fresh cheese dessert production in Russia, of which Stepanova writes in Dairy Industrial Technology Guide, Volume I., page 172 (Saint Petersburg, GIORG, 2000). Curdling according to procedure transpires by a symbiotic culture of mesophilic bacteria and one of yogurt bacteria, Streptococcus thermophilus. Yogurt cannot be produced by this procedure, thus neither can solid consistency yogurt cheese and yogurt dessert based on it.

Invention FR 2437996 A1 (Gantzer Jean Luis) refers to a yogurt-content dessert: an edible cup is made of sweet biscuit and filled with ice cream, yogurt etc. and coated with chocolate. This product is not included among yogurt desserts and its solidity is ensured by the sweet biscuit cup, not by the filling (corpus).

An examination of the market situation makes it clear that no yogurt cheese or yogurt dessert based on it, made as a fermented product having a solid consistency and retaining its shape, is known/marketed.

### SUMMARY OF THE INVENTION

An objective of the invention is, therefore, to create new chocolate-coated dessert products and method(s) for producing them, where the decisive raw material of the corpus of the dessert products is a fermented sour milk product of shape-sustaining solid consistency and containing live bacterial flora that has a higher nutritional value than fresh cheese used as the decisive raw material of the known chocolate-coated fresh cheese desserts, that has a more pleasant taste, a richer aroma content, a higher prestige value.

To achieve the objective, it has been examined what sour milk products can serve as base for producing the dessert raw material featuring the desired characteristics. We stipulate as basic characteristic of the main component that it should possess living bacterial flora beneficial in respect of nutrition. Thus we have chosen yogurt, sour dairy product the richest in these as the raw material of main component. We have developed the procedure according to invention with which shape-sustaining solid yogurt cheese is possible to produce out of yogurt, completely retaining the living bacterial culture evolved in the course of fermentation.

The invention relates, on the one hand, to a fresh yogurt cheese of solid consistency with live bacterial flora, as well as chocolate- or cocoa-paste-coated yogurt dessert piece products (product line) with live bacterial flora, prepared on the base of said fresh yogurt cheese, comprising as main component yogurt cheese of solid consistency with live bacterial flora obtained by curdling by a yoghurt culture of milk, or milk recombined from milk powder by water, preferably to a thicker consistency than milk, milk concentrated by ultra-filtering or milk powder, by cutting and heating the curd and separating the whey settled out.

The invention relates, on the other hand, to a method for the production of the above mentioned products by forming shape-sustaining dessert corpuses from the mass of yogurt cheese worked together cold with the ingredients according to the recipe, coating them with chocolate or cocoa paste, cooling and packaging them, whereas the dessert corpus may contain as a separate phase fruit jelly or other flavouring, a sponge flan and, moreover, the dessert corpus may contain yogurt cheese mass of two or more colours and flavours, constituting independent phases.

The invention is based on the realization that yogurt cheese similar to the Labneh type thick yogurt, but of a firmer consistency and consequently sustaining its shape will be suitable as decisive raw material of the corpus of the dessert product according to the invention, that is, it should have according to our production experiments a dry matter content of no less than 30% (w/v), preferably 33% (w/v) and a fat content not exceeding the 12% (w/v) value.

The invention is based also on the realization that during production of traditional fresh cheese heating applied to promote whey separation destroys a significant part of the heat-sensitive mesophilic lactic acid bacterial culture. On contrary, in the method according to the invention of producing yogurt cheese, the thermophilic yogurt bacterial culture being applied preserves its viability during heating for the same purpose. Consequently, yogurt desserts according to invention made on the base of the yogurt cheese will be biologically active products. This gives them a market edge.

The invention is also based on the realization that in the course of production procedure of yogurt cheese as main component of yogurt desserts according to invention if prepared yogurt curd is cut and heated up to the limit of 55° C., inside curd the protein reticulation structure evolves which ensures convenient shape-sustaining solidity after removal of unnecessary whey by pressing up to reaching dry matter content of 30-35% (w/v).

The invention is as well based on the realization that heating, serving to solidify curd should be performed practically up to reaching 55° C., as according to our experience until this temperature limit can the viability of yogurt bacteria flora evolved in curd be fully maintained.

The invention is based also on the realization that chocolate- or cocoa-paste-coated yogurt desserts produced by the method according to the invention are more popular due to their taste that is richer in aroma and more pleasant, due their higher nutritional value, and because the taste of yogurt is, in contrary to the taste of fresh cheese, more popular to the majority of people, they like it and associate yogurt products with higher prestige value. Consequently, they could be successful rivals to, and could even replace traditional fresh cheese and the desserts made on their base. This was confirmed by a group of consumers: all participants found the desserts made on the base of yogurt cheese according to the invention more tasty and richer in aroma than traditional desserts made on the base of traditional fresh cheese.

The invention is based also on the realization that, in contrast to the traditionally applied method of producing fresh cheese, the production of yogurt cheese and yogurt desserts according to the invention by the method according to the invention while maintaining quality is more economical due to its smaller equipment and energy needs, provided that milk recombined thicker than common milk or milk concentrated to a smaller water content is applied as raw material to be fermented. This realization has been confirmed by the technological experiments we conducted and by the organoleptic comparison of the obtained products.

Yogurt cheese has been manufactured by the method according to the invention:
i.) from skimmed milk of 0.1 wt % fat content, 8% (w/v) fat-free dry matter content,
ii.) from the dispersed mixture of skimmed milk of 0.1 wt % fat content, 8% (w/v) fat-free dry matter content and skimmed milk powder prepared so as to have 16% (w/v) fat-free dry matter content, i.e. twice as concentrated as normal skimmed milk,
iii.) from the dispersed mixture of skimmed milk powder and water prepared so as to have 24% (w/v) fat-free dry matter content, i.e. thrice as concentrated as normal skimmed milk.

During testing, the participants could not distinguish by tasting the three types of yogurt cheese made with normal skimmed milk and with recombined milk twice or thrice as concentrated as skimmed milk, respectively, nor the three types of coated yogurt desserts made on their respective bases, having the same characteristics in every other respect.

The objective of the invention is realized by applying, based on the above realizations, as decisive raw material of the corpus of the chocolate-coated desserts according to the invention and concurrently as the main components of the desserts the solid consistency yogurt cheese, and thus the product according to the invention, the coated yoghurt piece dessert with live bacterial flora, comprises with reference to the finished product:
yogurt cheese of solid consistency with live bacterial flora, of further 30-35% (w/v) dry matter content in excess of 50% (w/v), obtained by pasteurisation of the dispersed mixture of milk or skimmed milk, or milk or skimmed milk concentrated by ultra-straining, preferably with water or skimmed milk powder, to 8-24% (w/v) fat-free dry matter content, set at 0-5% (w/v) fat content with butter, cream or solid vegetable fat containing no trans fats, its acidic curdling by a preferably lyophilised, thermophilic yogurt bacteria culture including Streptococcus thermophilus and Lactobacillus delbrueckii bulgaricus bacterial strains and its occasional supplementary inoculating fermentation, curd solidification by heating and the removal of the unnecessary part of the whey being created,
8-15% (w/v) sugar or other sweetener replacing that partly/wholly,
0-15% (w/v) butter and/or solid vegetable fat containing no trans fats, preferably margarine containing omega-3 fatty acid,
0-5.0% (w/v) skimmed milk powder,
0-15% (w/v) jam, fruit jelly or other flavouring, mixed in the corpus material of the dessert or constituting a separate phase in the corpus,
0-0.1% (w/v) lemon or vanilla aroma,
1-2.0% (w/v) viscosity-enhancing, whey-separation-reducing auxiliary material of anti-microbial and anti-oxidant content,
food colorant, if we desire to colour the material of the corpus.

Said materials, mixed into a homogenous mass, constitute the corpus of the dessert; and in addition, the product comprises in form of an evenly applied coating on the corpus, with reference to the finished product:
a chocolate or cocoa coating paste of 20-35% (w/v).

The product is moulded into a bar, cubic or spherical shape of round, square, rectangular other cross-section and wrapped into foil with or without applying protective gas.

In addition to the above components, the dessert may also contain approved preservatives.

A possible method according to the invention for making the yogurt cheese constituting the main component of the desserts according to the invention is the following: milk is pasteurized at a temperature of 90-95° C., in the meantime, its fat content is set preferably at the value of 0.1-1.5% (w/v), it is homogenised at high pressure, cooled to a temperature of 40-45° C., preferably 42° C. and poured into a cheese tank/cheese vat where it is inoculated by the amount of yogurt bacterial culture corresponding, it is fermented at this temperature until reaching the pH value of 4.6-4.4, the curd being obtained is cut into cubes with edges of 1-2 cm length, the mixture is heated to a maximum temperature of 55° C. to solidify the protein network and enhance whey separation (syneresis) until reaching the appropriate thickness of the curd while sparing its live flora, whey is separated from the yogurt curd, unnecessary whey is pressed from the curd until the desired, preferably 33% (w/v), dry matter content is attained and thus a yogurt cheese of solid consistency, with live bacterial flora, is obtained.

Yogurt cheese is homogenised in a mixer-homogenisator with the components according to various recipes, the obtained mass is cooled preferably to a temperature of 4° C. and moulded into shape-sustaining dessert corpuses preferably by a multiline moulding machine of regulated pressure, coating them with chocolate or cocoa coating paste, then cooling and packaging them. Thus yogurt dessert piece products according to the invention are made.

As another implementation of the method according to the invention, for producing yogurt cheese constituting the main component of the desserts, a raw material that is much more concentrated than milk is used: from skimmed milk concentrated by ultra-filtering, or from the dispersed mixture of skimmed milk concentrated with milk powder, or of skimmed milk powder prepared with water, said mixtures having preferably 16-24% (w/v) fat-free dry matter content.

The method typically comprises following steps:
a) the quantity of skimmed milk powder required for attaining preferably 16-24% (w/v) dry matter content is introduced into water/skimmed milk heated to a temperature of 50° C. preferably by a disperser device and will be exposed in 2-3 hours while the mixture is being stirred continuously,
b) after exposition, the mixture is pasteurized at a temperature of 90-95° C. (given the absence of fat, no high-pressure homogenisation is necessary), cooled to a temperature of 40-45° C. and transferred to a cheese tank/cheese vat,
c) the mixture is inoculated by thermophilic yogurt lactic acid bacterial culture, it is fermented preferably at 42° C. temperature until a pH value of 4.6-4.4 is attained, the received curd is cut into to cubes of 1-2 cm edge length, the mixture is heated to a maximum temperature of 55° C. to spare its live flora and in order to solidify the protein network and enhance whey separation until appropriate curd solidity is attained,
d) the curd-whey mixture is drained from the cheese tank/cheese vat, a major part of whey is separated by straining, the unnecessary amount of whey is pressed from the curd until the desired, preferably 33% (w/v), dry matter content is attained, as a result of which yogurt cheese of solid consistency, with live bacterial flora is obtained.

Beneficial impacts resultant from invention correlated with the state of technology:
1. Food product according to invention is the first and so far the only living flora yogurt dessert piece good which meets the dual requirement of:
   viable colony count of yogurt bacteria reaches 10⁷ CFU/g value throughout its best before period
   The milk-based simple product ratio reaches 70% (w/v)
2. Yogurt dessert according to invention is more valuable in respect of nutrition than known fresh cheese desserts, as its living bacterial flora is provided by yogurt bacteria having beneficial effect on the alimentary tract, while known fresh cheese desserts contain mesophilic bacteria culture possessing no such effect.
3. Viable colony count CFU/g of yogurt dessert according to invention is multiple of the viable colony count CFU/g of yogurt curd prepared for its production. Hence nutrition physiology value of dessert according to invention is even higher than at natural and greek style yogurts. This benefit is explicable by the recognition, that the protein network formed through solidifying of curd provides an optimal living environment for yogurt bacteria. For this reason a small amount of yogurt bacteria is gone during whey separation, and due to this viable colony count CFU/g of solid curd grows. According to our experience the viable colony count CFU/g of yogurt cheese of 33% (w/v) dry matter content is multiple of natural yogurt, however the viable colony count CFU/g of separated whey is only 1/10 of viable colony count CFU/g of yogurt cheese on an average.
4. Yogurt dessert according to invention is considered to be tasty and aromatic by the majority of consumers, as amidst aroma compounds generated by yogurt bacteria aldehydes dominate, which are liked by consumers. By contrast, among aroma compounds of fresh cheese dessert diacetyl dominates, which is only evaluated by people who are accustomed to fresh cheese containing foodstuff consumption since their childhood.
5. According to process of invention at preparation of dessert corpus mass a relatively low-energy consuming mixer-homogenizer is applied. It infringes protein network to only a small measure and thus promotes shape-sustaining solidity of dessert corpus. In contrast, at fresh cheese dessert production commonly cutters with strong cutting effect and high-energy consumption are applied, by means of which dehydrated hard cores evolved at heating up of mesophilic curd are shredded together with homogenization.

The methods according to the invention for producing yogurt cheese and yogurt desserts will be illustrated by the following examples, without limiting either the applicability of the invention or the scope of the patent applied for to those:

### EXAMPLE 1

Method for the Production of Yogurt Cheese with Live Bacterial Flora from Milk

Cow milk is pasteurized by a plate pasteurizer device at 95° C., so that, in the meantime, the fat content of milk is set to 1.5% (w/v) by the skimming machine, it is homogenised by homogeniser, pumped into a heatable/coolable cheese tank/cheese vat provided with mixer at a temperature of 42° C., inoculated by the amount of yogurt bacterial culture of type YC-380 corresponding to the standardised quantity and curdled at this temperature, until the pH value of 4.6-4.4 is attained. The mixer of the tank/vat is replaced by a stringed cutting tool and the curd is cut into cubes of 1-2 cm edge length, the mixture is heated while being gently stirred until the adequate firmness of the curd is attained, taking care that its temperature should not exceed 55° C. in order to preserve the live flora. After the intensity of whey separation had decreased, the bigger part of whey is removed from the tank/vat through a straining basket. The curd/whey mixture remaining in the tank/vat is drained preferably into a cart with perforated bottom preferably of the BUDAGÉP type, and the unnecessary whey is removed from the curd by using the pneumatic press structure of the cart, preferably until reaching 30-35% (w/v) dry matter content in the curd.

With that the solid yogurt cheese with live bacterial flora is made, it is cooled preferably to a temperature of 4° C. and stored refrigerated until use.

### EXAMPLE 2

Method for the Production of Yogurt Cheese with Live Bacterial Flora from the Mixture of Milk Powder and Water Prepared so as to Have 16% Fat-Free Dry Matter Content

Water of a temperature of 50° C. is poured into a preparatory tank provided with mixer. With the help of a disperser device comprising a powder mixing tank and a shear-cutter pump connected to it by circulation pipeline, preferably of the BUDAGÉP type, the quantity of skimmed milk powder required for attaining 16% (w/v) dry matter content is added to the water in the preparatory tank as well as preferably the quantity of butter or solid vegetable fat required to have 3% (w/v) fat content, and the mixture is dispersed with constant circulation for two hours.

The dispersed mixture prepared this way, that is actually recombined fat-free milk that is twice as concentrated as milk of 1.5% (w/v) fat content, is pasteurized by plate pasteurizer device at a temperature of 90±95° C., homogenised by high-pressure homogeniser device and pumped over at a temperature of 42° C. into a heatable/coolable cheese preparation tank facilitating crud separation, designed with conical bottom, preferably of the BUDAGÉP type, it is inoculated by the amount of yogurt bacterial culture of type YC-380 corresponding to the standardised quantity and it is curdled at this temperature until the pH value of 4.6-4.4 is attained. The received curd is cut into cubes of 1-2 cm edge length by a stringed cutter device, the mixture is heated while being gently stirred until the adequate firmness of the curd is attained, taking care that its temperature should not exceed 55° C. in order to preserve the live flora. After the intensity of whey separation had decreased, the curd/whey mixture is drained into a cart with perforated bottom, preferably of the BUDAGÉP type, and the unnecessary whey is removed from the curd by using the pneumatic press structure of the cart, preferably until reaching 30-35% (w/v) dry matter content in the curd.

With that a solid yogurt cheese with live bacterial flora required for making the material of the corpus of yogurt desserts according to the invention, of optimum composition, containing fat, is made, that is preferably cooled to a temperature of 4° C. and stored refrigerated until use.

### EXAMPLE 3

Method for the Production of a Plain Chocolate-Coated Yogurt Dessert Bar Piece Product with Live Bacterial Flora

Yogurt cheese with live bacterial flora is produced by the method described in Examples 1, or 2 above, preferably of 33% (w/v) dry matter content, cooled to a temperature of 4° C. and worked together with the ingredients measured out according to the following recipe by a mixer-homogeniser preferably of the BUDAGÉP type into a quasi-homogenous white plain yogurt cheese:
74 kg yogurt cheese,
10 kg butter (80% fat content),
16 kg beet sugar,
100 g lemon powder aroma of type AB 352,
2 kg additives of type PROMIKOLL.

The mass thus obtained, that serves as raw material of the dessert corpus, is cooled to a temperature of 4° C., moulded into bars of a diameter of 18 mm and a length of 50-80 mm by a multi-line moulding machine of regulated pressure, preferably of the BUDAGÉP type, the entire surface of the corpuses is coated by the amount of chocolate corresponding to 30% (w/v) with reference to the finished dessert product in a dipping machine. The desserts made this way are gently cooled to a temperature of 10° C. in a cooling tunnel, then wrapped, preferably one by one by a “flow-pack” packaging machine provided with automatic feeding unit, with or without applying protective gas, preferably of the BUDAGÉP LINEPACK type, into BOPP foil prepared by printing, packed into multipack boxes and stored refrigerated at a temperature of 4° C. until delivery.

### EXAMPLE 4

Method for Making Chocolate-Coated, Flavoured Yogurt Dessert Bar Piece Products with Live Bacterial Flora

Dessert product is made by the method as described in Example 3, with the difference that the material of the dessert corpus is a coloured, flavoured yogurt cheese mass, made according to the following recipe:
72 kg yogurt cheese,
10 kg vegetable fat (70% fat content),
12 kg beet sugar,
4 kg fruit jelly (sour cherry, currant apricot, strawberry, banana or other) with adequate colourant content,
100 g vanilla powder aroma of type AB-678,
2 kg additives of type PROMIKOLL.

### EXAMPLE 5

Method for Making Cocoa-Paste-Coated, Filled Yogurt Dessert Bar Piece Product with Live Bacterial Flora

Yogurt cheese with live bacterial flora is produced by the method as described in Examples 1, or 2, preferably with dry matter content of 33% (w/v), cooled to a temperature of 4° C. and worked together to a quasi-homogeneous plain yogurt cheese mass preferably in a mixer-homogeniser preferably of the BUDAGÉP type with the materials weighted out according to the following recipe:
76 kg yogurt cheese,
13 kg margarine of omega-3 fat content (50% fat content),
9 kg cane sugar,
100 g lemon powder aroma, brand AB 352,
2 kg additives of type PROMIKOLL FC-10 ABS 02.

The mass thus obtained, that is to serve as raw material of the dessert corpus, is cooled to a temperature of 4° C., moulded into bars of a diameter of 18 mm and a length of 50-80 mm by a multi-line moulding machine with pressure control preferably of the BUDAGÉP type, so that through the injector tubes located in the axis line of the corpus-shaping pressure pipes of the moulding machine bars of jam, fruit pulp, caramel, sweetened chestnut purée, nut or other located in the axis line of the dessert corpuses are made in a quantity of 4% (w/v) with reference to the finished dessert product. The entire surface of the corpuses is coated in the dipping machine with cocoa paste of 30% (w/v) with reference to the finished dessert product. The desserts made this way are cooled to a temperature of 6° C. in a cooling tunnel, then wrapped, preferably one by one or two by two by a “flow-pack” packaging machine provided with automatic feeding unit, with or without applying protective gas, preferably of the BUDAGÉP LINEPACK type, into BOPP foil prepared by printing, packed into multipack boxes and stored refrigerated at a temperature of 4° C. until delivery.

### EXAMPLE 6

Method for Making a Cocoa-Paste-Coated, Layered White Yogurt Dessert Bar with Live Bacterial Flora

A dessert product is produced by the method as described in Example 5, with the difference that cuboids (bars) of a width of 35 mm, a height of 18 mm and a length of 80 mm are moulded of the white, plain yogurt cheese mass serving as raw material for the dessert corpus by a multiline moulding machine preferably of the BUDAGÉP type so that, through the injector pipes with flat outlet located along the longitudinal axis of the cross-section of the corpus-moulding pressure pipes of the moulding machine, jam, fruit pulp, sweetened chestnut purée, nut or other cream product is introduced from one edge of the corpus to the opposite edge as a layer of a thickness of 2 mm, constituting a separate phase in the dessert corpus, and the surface of the dessert corpuses is coated by the amount of cocoa paste corresponding to 20% (w/v) of the finished dessert product.

### EXAMPLE 7

Method for Making Cocoa-Paste-Coated Yogurt Bar Product with Sponge Cake, with Live Bacterial Flora

Yogurt cheese with live bacterial flora is made by the method as described in Examples 1, or 2, preferably with 33% (w/v) dry matter content, cooled to a temperature of 4° C. then worked into a quasi-homogenous white, plain yogurt cheese mass by a mixer-homogeniser preferably of the BUDAGÉP type with the materials weighted out according to the following recipe:
74 kg yogurt cheese,
10 kg butter (80% fat content),
14 kg beet sugar,
100 g lemon powder aroma of type AB 352,
2 kg additives of type PROMIKOLL.

Sponge cake strips of a width of 35 mm and a thickness of 4 mm are made by a separate procedure, and the white, plain or coloured, flavoured yogurt cheese mass made by a separate procedure is applied on the entire width of the sponge cake strips, as a layer of a height of 12 mm, by continuous feed, by a multiline moulding machine preferably of the BUDAGÉP type, the continuous cuboid being formed is cut to pieces of a length of 80 mm, said finished pieces constituting the corpus of the dessert. The entire surface of the corpuses is covered by applying the amount of cocoa coating corresponding to 20% (w/v) of the finished product in a dipping machine, and the desserts prepared this way are cooled to a temperature of 6° C. in a cooling tunnel, then wrapped one by one or two by two by a “flow pack” packaging machine preferably of the BUDAGÉP LINEPACK type, provided with automatic feeder, with or without applying protective gas, into BOPP foil prepared by printing, then put into multipack boxes and stored refrigerated at a temperature of 4° C. until delivery.

1. A yogurt product, of solid consistency, coated by chocolate or cocoa paste, with live bacterial flora, the yogurt product comprising:
milk product as a main component: fresh yogurt cheese with bacterial flora, of firm consistency, of 30-35% (w/v) dry matter content, obtained by pasteurisation of the dispersed mixture of milk or skimmed milk, or milk or skimmed milk concentrated by ultra-straining, preferably with water or skimmed milk powder,—to 8-24% (w/v) fat-free dry matter content, set at 0-5% (w/v) fat content with butter, cream or solid vegetable fat containing no trans fats, its acidic curdling, by a preferably lyophilised, thermophilic yogurt bacteria culture including Streptococcus thermophilus and Lactobacillus delbrueckii bulgaricus bacterial strains and its occasional supplementary inoculating fermentation, curd solidification by heating and the removal of the unnecessary part of the whey being created,
0-15% (w/v) butter and/or solid vegetable fat containing no trans fats, preferably containing omega-3 fatty acids,
0-5.0% (w/v) milk powder,
8-15% (w/v) sugar or other sweetener replacing that partly/wholly,
0-20% (w/v) jam, fruit jelly or other flavour material, mixed in the dessert corpus material or constituting a separate phase in the corpus,
0-0.1 (w/v) lemon or vanilla aroma,
1.0-2.0% (w/v) viscosity-enhancing, whey-separation-reducing auxiliary material of anti-microbial and anti-oxidant content,
food industrial colourant in an amount corresponding to the standardised quantity, it the dessert corpus material is to be coloured,
potentially: approved preservative(s),
the above listed materials, after being mixed into a homogenous mass, constitute the corpus of the dessert and, in addition, the product furthermore comprises, in form of an evenly applied coating on the corpus, with reference to the finished product:
a chocolate or cocoa coating paste of 20-35% (w/v),
the product is moulded into a bar, cubic or spherical shape of round, square, rectangular or other cross-section and wrapped preferably one by one, with or without introducing protective gas, into a foil.

2. The yogurt dessert piece product according to claim 1, wherein the dessert corpus contains as separate phase: 0-30% (w/v) sponge flan, fondant material.

3. A method for producing the yogurt dessert according to claim 1, wherein milk/skimmed milk or milk/skimmed concentrated to 8-24% (w/v) fat-free dry matter content is applied for producing the main component of the dessert, its fat content is set at the value of 0-5% (w/v) with butter, cream or vegetable fat containing no trans fats, it is pasteurized at a temperature of 90-95° C., homogenised, cooled, curdled with thermophilic yogurt bacterial culture preferably at a temperature of 42° C. until reaching a pH value of 4.6-4.4, the curd is cut into cubes of 1-2 cm edge length, solidified by heating to a maximum temperature of 55° C. then whey is separated from the curd, yogurt cheese is obtained by pressing the unnecessary whey from the curd that is then cooled to a maximum temperature of 4-6° C. then in a mixer-homogenizator equipment worked into a homogenous mass with the materials according to the recipe: sugar, butter and/or solid vegetable fat, preferably margarine containing omega-3 fatty acids, flavours, preferably fruit jelly, aroma, improver and preservative additives, the mass obtained is moulded into a bar, cube or spherical shape of square, cube, rectangular or other cross-section preferably by extrusion, by a multiline moulding machine, coated over its entire surface by chocolate or cocoa-flavoured coating on a coating machine, cooled in a cooling tunnel, and wrapped with or without introducing protective gas, into foil by a “flow pack” system packaging machine.

4. The method according to claim 3, wherein, as initial material for the production of the main milk product component of the dessert, the dispersed mixture of milk and milk powder, water and skimmed powder made with 8-24% (w/v) fat-free dry matter content concentration and set at 0-5% (w/v) fat content with butter, cream or solid vegetable fat containing no trans fats is applied, and prior to pasteurisation, milk powder in the mixture is exposed at its temperature of around 50° C. over 2-3 hours.

5. The method according to claim 3, wherein during the moulding of the dessert corpus, flavouring material, preferably fruit jelly, constituting a separate phase, is introduced into the corpus by continuous injection.

6. The method according to claim 3, wherein the dessert corpus is moulded of the homogeneous mass of yogurt cheese and other ingredients constituting two or more separate phases, of diverse flavour and colouring, according to the recipe.
